(19) United States
(12) Patent Application Publication
(10) Pub. No.: US 2011/0158644 A1
(43) Pub. Date: Jun. 30, 2011

(54) IN OR RELATING TO MULTICARRIER COMMUNICATION

(76) Inventors: Fabio Cavaliere, Pisa (IT); Pierpaolo Ghiggino, Pisa (IT)

(21) Appl. No.: 12/675,018

(22) PCT Filed: Aug. 30, 2007
(86) PCT No.: PCT/EP2007/059075

§ 371 Date: Mar. 7, 2011

(51) Int. Cl. H04J 14/00

(52) U.S. Cl. 398/43

(57) ABSTRACT

The invention relates to improvements in or relating to multicarrier communication and includes a method and a system for communication between an optical line terminal and a plurality of users over a single optical fibre. A portion of a down-stream optical signal is input to an optical circuit, the downstream signal comprising a plurality of subcarriers modulated at a first frequency, the portion of the downstream optical signal is processed at the optical circuit to remove the plurality of subcarriers and to change the first frequency into a second frequency. The processed portion of the downstream signal is then used for communication in the upstream direction.

The invention relates to improvements in or relating to Multicarrier Communication and in particular, but not exclusively, to improvements in or relating to Subcarrier Multiplexing.

Subcarrier Multiplexing (SCM) is a modulation format particularly suitable for optical fibre point-to-multipoint applications, such as the delivery of cable television to multiple users via an optical network such as a passive optical network. SCM can be used for multiplexing many different fibre optic communication links into a single optic fibre using radio frequency modulation. The data to be transmitted is first modulated on a wide carrier in the GHz range (i.e. radio frequency range) which is subsequently modulated in the THz range (i.e. optical frequency range). The receiver of the data tunes to the correct subcarrier frequency thereby filtering out the other subcarriers. Multiplexing and demultiplexing of the single subcarriers is carried out electronically whereas modulating the multiplexed signal is carried out optically.

SCM can also be used to transfer data in the upstream direction such as voice or video traffic. This can be achieved over the same optical fibre which is used to transmit upstream and downstream data. Typical SCM systems use SCM frequencies in the upstream direction that are the same as the SCM frequencies in the downstream direction. This has the disadvantage of potentially producing interference in the downstream or upstream data paths. This problem may still persist even if the downstream signal is much weaker than the upstream signal. This is mainly due to reflections due to Rayleigh backscattering in the optical fibre or in splices of the optical fibre and in optical connectors. Such reflections are a cause of interference which degrades the receiver performance. In an attempt to overcome this problem it has been proposed to use different SCM frequencies in the upstream and downstream directions.

One way of minimising these problems is to generate the upstream frequencies independently of the downstream frequencies by using a laser at the user end emitting at a frequency fᵤ, different from the downstream frequency f_{d}. The difference (fᵤ−f_{d}) must be larger than the receiver bandwidth to avoid interference. However, in an access network the equipment which aggregates and modulates the subcarriers, possibly including the laser, is usually placed in a remote cabinet close to the user. Such a remote cabinet imposes strict requirements in terms of cost, power consumption and reliability. These requirements could not be met by typical laser specifications, especially when Wavelength Division Multiplexing (WDM) transmission is used to increase the system capacity. Such a laser would be required to have a stable frequency output and must not interfere with adjacent WDM channels. The laser would also be required to be tuneable to ensure colourless operation and to minimize the inventory of the remote cabinet and simplify the network management. Such requirements would further increase the costs which means that using a laser to generate the upstream frequencies independently of the downstream frequencies is prohibitively expensive.

Another known technique is to generate the upstream SCM frequencies by remodulating the downstream SCM frequencies so that the upstream and downstream frequencies are the same. This has the advantage of avoiding the requirement for an expensive laser at the user location. A problem associated with the technique is that the downstream signal may still interfere with the upstream signal which causes a penalty in terms of signal quality.

SCM systems may use Semiconductor Optical Amplifiers (SOA) which are non-linear optical devices. Such SOAs may give rise to intermodulation product frequencies among the subcarriers of a SCM signal particularly when different SCM subcarrier frequencies are used in the upstream and downstream directions. When an intermodulation product frequency coincides with a subcarrier frequency it may affect the Bit Error Rate (BER) performance of the SCM system which is undesirable.

What is required is a way of improving multicarrier communication whilst minimising the cost and reducing the above-mentioned problems.

According to a first aspect of the invention, there is provided a method of operating a multicarrier communications system for communication between an optical line terminal and a plurality of users over a single optical fibre comprising;
inputting a portion of a downstream optical signal to an optical circuit, the downstream signal comprising a plurality of subcarriers modulated at a first frequency;
processing the portion of the downstream optical signal at the optical circuit to remove the plurality of subcarriers and to change the first frequency into a second frequency; and
using the processed portion of the downstream signal for communication in the upstream direction.

Such a method combines the advantage of transmitting at different frequencies in the downstream and the upstream direction and the advantage of reusing the downstream signal to generate the upstream signal. Reusing the downstream signal avoids the requirement for expensive laser equipment at or near to the user location. Using different frequencies in the upstream and the downstream direction also avoids any problems due to reflection points.

Preferably the method further includes using an optical tap for inputting the portion of the downstream optical signal to the optical circuit. The portion of the downstream optical signal may be any percentage of the optical power of the full downstream signal but preferably 30-50% of the optical power of the downstream optical signal. In a preferred embodiment the portion of the downstream optical signal is substantially 40% of the optical power of the downstream optical signal.

Preferably the method further includes using an optical carrier recovery device to remove the plurality of subcarriers.

Preferably the method further includes using a delay line interferometer in the optical carrier recovery device to introduce a phase shift of π radians and a relative delay of Δf⁻¹ where Δf is the frequency separation between two adjacent subcarriers.

Preferably the method further includes using the delay line interferometer to produce a frequency response H(f) according to the equation:

$$H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) ,$$

where f is a frequency offset from the first frequency.

Preferably the method further includes using a control circuit to control the delay line interferometer.

The method may further include using an optical frequency shifter to change the first frequency into the second frequency.

Preferably the method includes performing Optical Signal Side Band (OSSB) modulation to produce the second frequency.

The method may further include using a dual arm Mach-Zender modulator to the perform Optical Signal Side Band (OSSB) modulation.

Preferably the method further includes inputting the processed portion of the downstream signal to an upstream modulator for communication in the upstream direction.

Preferably the multicarrier communication system is a sub-carrier multiplexing carrier system.

According to a second aspect of the invention there is provided a multicarrier communications system for communication between an optical line terminal and a plurality of users over a single optical fibre comprising;
an optical circuit for receiving a portion of a downstream optical signal, the downstream signal comprising a plurality of subcarriers modulated at a first frequency;
the optical circuit comprising an optical carrier recovery device and an optical frequency shifter to process the portion of the downstream optical signal to remove the plurality of subcarriers and to change the first frequency into a second frequency; wherein the processed portion of the downstream signal is arranged for communication it) in the upstream direction.

Preferably the multicarrier communications system includes an optical tap to input the portion of the downstream optical signal to the optical circuit. The portion of the downstream optical signal may be any percentage of the optical power of the full downstream signal but preferably 30-50% of the optical power of the downstream optical signal. In a preferred embodiment the portion of the downstream optical signal is substantially 40% of the optical power of the downstream optical signal.

Preferably the multicarrier communications system includes a delay line interferometer in the optical carrier recovery circuit to introduce a phase shift of it radians and a relative delay of Δf⁻¹ where Δf is the frequency separation between two adjacent subcarriers.

Preferably the multicarrier communications system includes operating the delay line interferometer to produce a frequency response H(f) according to the equation:

$$H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) ,$$

where f is a frequency offset from the optical carrier frequency.

Preferably the multicarrier communications system includes a control circuit to control the delay line interferometer.

The multicarrier communications system may include arranging the optical frequency shifter to perform Optical Signal Side Band (OSSB) modulation to produce the second frequency.

The multicarrier communications system may include a dual arm Mach-Zender modulator to perform the Optical Signal Side Band (OSSB) modulation.

Preferably the multicarrier communications system includes an upstream modulator to receive the processed portion of the downstream signal for communication in the upstream direction.

Preferably the multicarrier communication system is a sub-carrier multiplexing carrier system.

According to a third aspect of the invention there is provided an optical circuit for receiving a portion of a downstream optical signal in a multicarrier communications system for communication between an optical line terminal and a plurality of users over a single optical fibre, the downstream signal comprising a plurality of subcarriers modulated at a first frequency,
the optical circuit comprising an optical carrier recovery device and an optical frequency shifter to process the portion of the downstream optical signal to remove the plurality of subcarriers and to change the first frequency into a second frequency, wherein the processed portion of the downstream signal is arranged for communication in the upstream direction.

Preferably the optical circuit is arranged to receive the portion of the downstream optical signal from an optical tap. The portion of the downstream optical signal may be any percentage of the optical power of the full downstream signal but preferably 30-50% of the optical power of the downstream optical signal. Preferably the portion of the downstream optical signal is substantially 40% of the optical power of the downstream optical signal.

Preferably the optical circuit has a delay line interferometer in the optical carrier recovery circuit to introduce a phase shift of π radians and a relative delay of Δf⁻¹ where Δf is the frequency separation between two adjacent subcarriers.

Preferably the optical circuit further includes operating the delay line interferometer to produce a frequency response H(f) according to the equation:

$$H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) ,$$

where f is a frequency offset from the optical carrier frequency.

Preferably the optical circuit further includes a control circuit to control the delay line interferometer.

Preferably the optical circuit further includes arranging the optical frequency shifter to perform Optical Signal. Side Band (OSSB) modulation to produce the second frequency.

The optical circuit may further include a dual arm Mach-Zender modulator to perform the Optical Signal Side Band (OSSB) modulation.

Preferably the optical circuit further includes an upstream modulator to receive the processed portion of the downstream signal for communication in the upstream direction.

Preferably the optical circuit is arranged to operate with a sub-carrier multiplexing carrier system.

According to a fourth aspect there is provided a communications network including a method according to the first aspect, a system according to the second aspect or an optical circuit according to the third aspect.

Other features of the invention will be apparent from the following description of preferred embodiments shown by way of example only with reference to the accompanying drawings, in which;

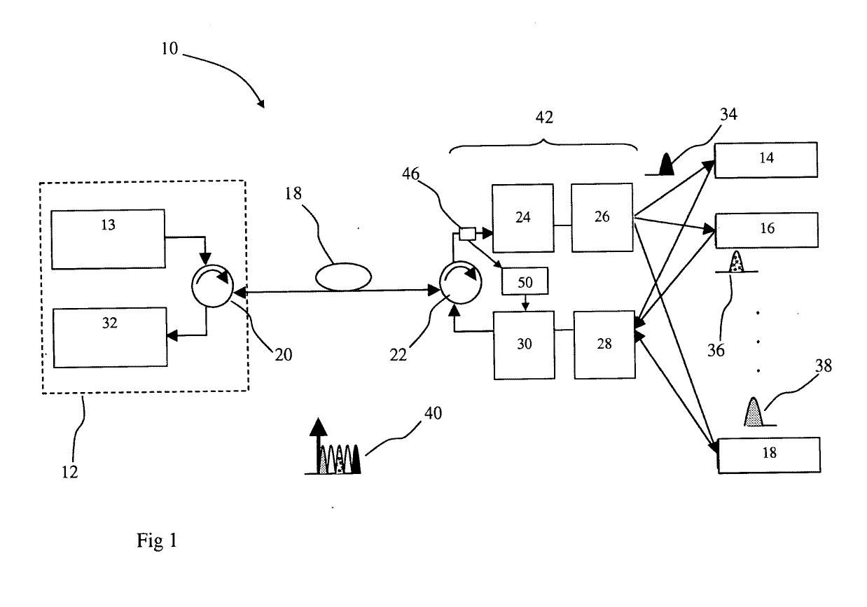

FIG. 1 shows a network according to an embodiment of the invention;

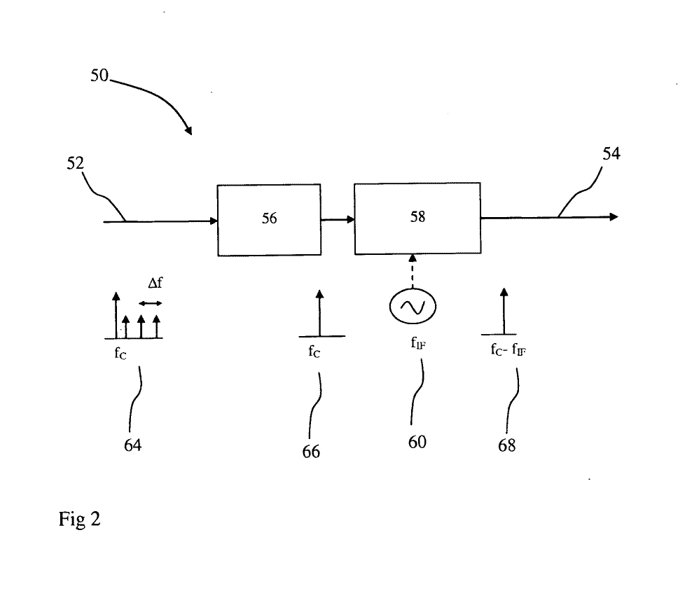

FIG. 2 shows an optical circuit for use in the network of FIG. 1 according to an embodiment of the invention;

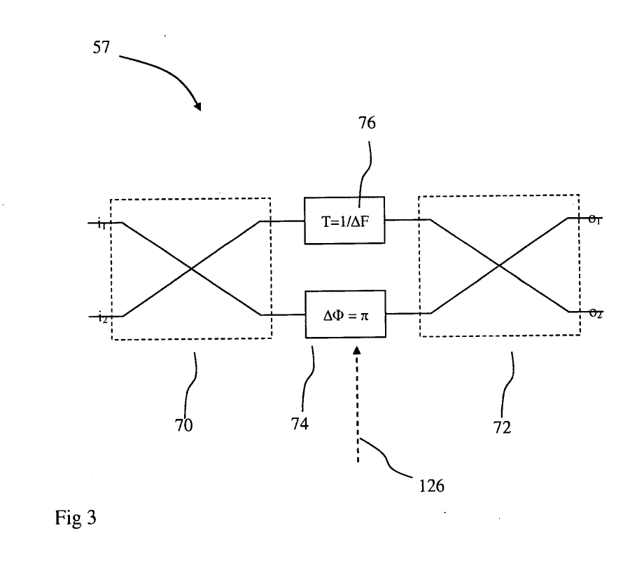

FIG. 3 shows a delay line interferometer used in FIG. 2;

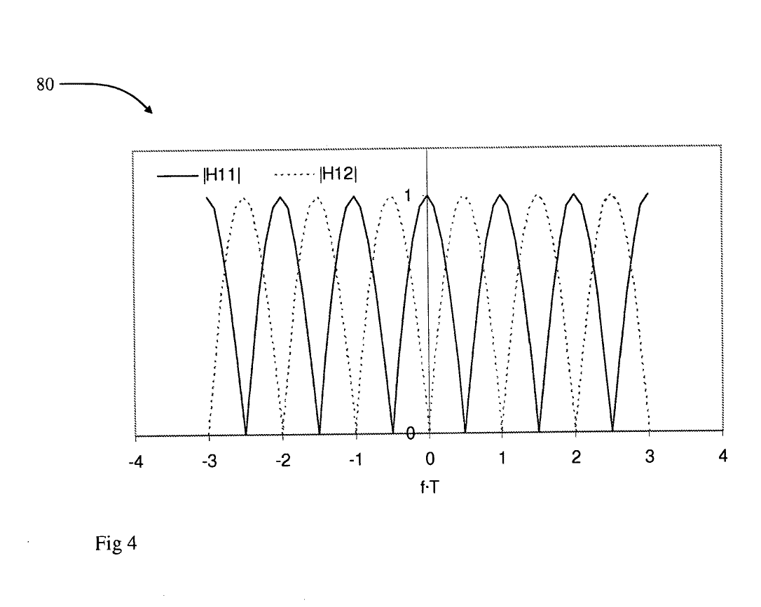

FIG. 4 shows a plot of a function H(f) of equation (1);

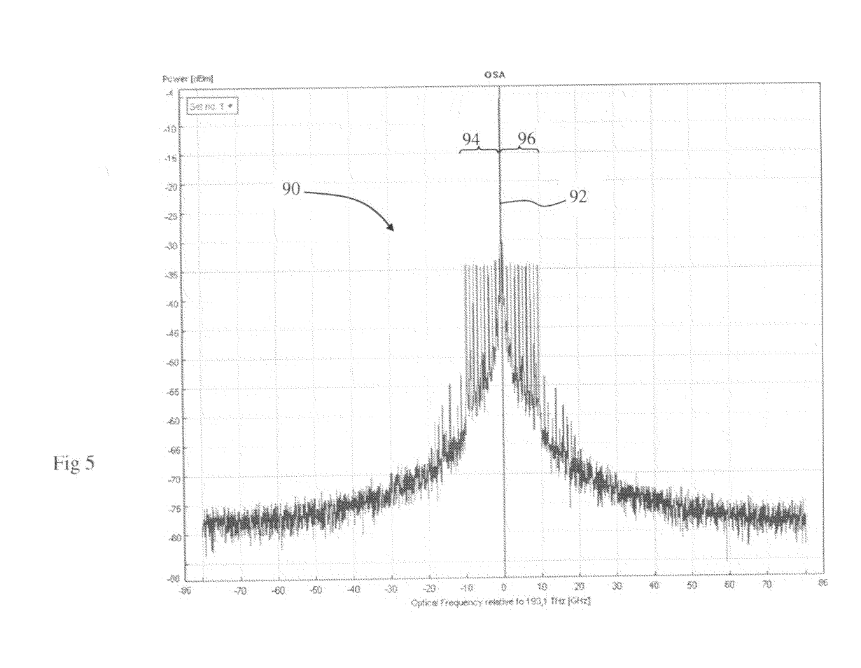

FIG. 5 shows an input SCM spectrum at the input port i₁ shown in FIG. 3;

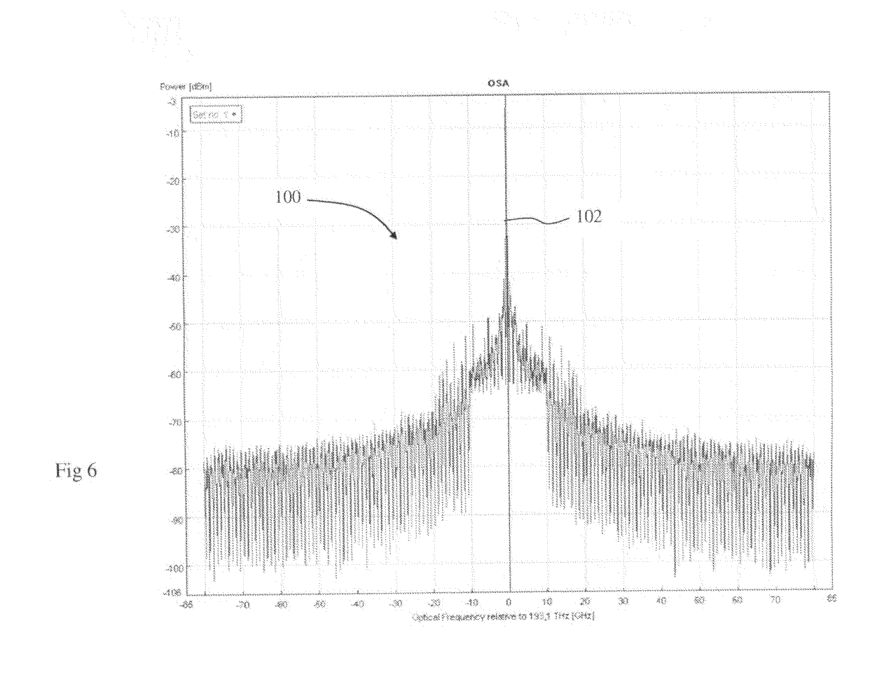

FIG. 6 show an output spectrum at output port o₁ shown in FIG. 3;

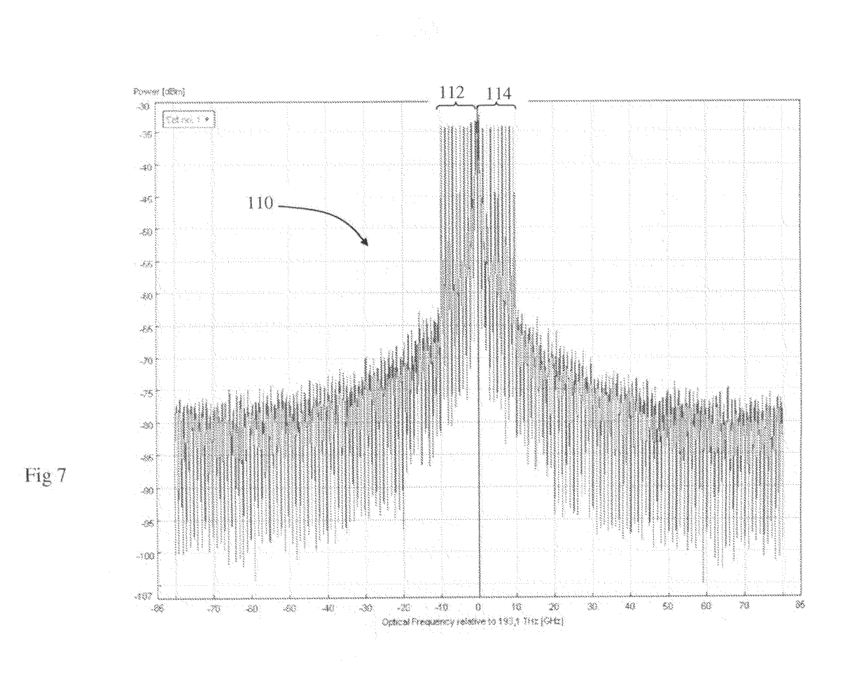

FIG. 7 show an output spectrum at output port o₂ shown in FIG. 3;

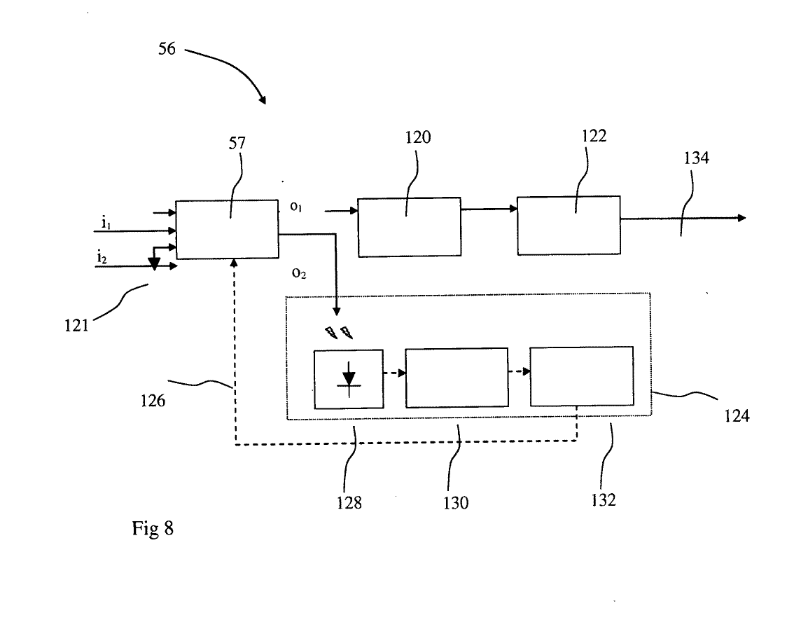

FIG. 8 shows the carrier recovery circuit of FIG. 2 in greater detail;

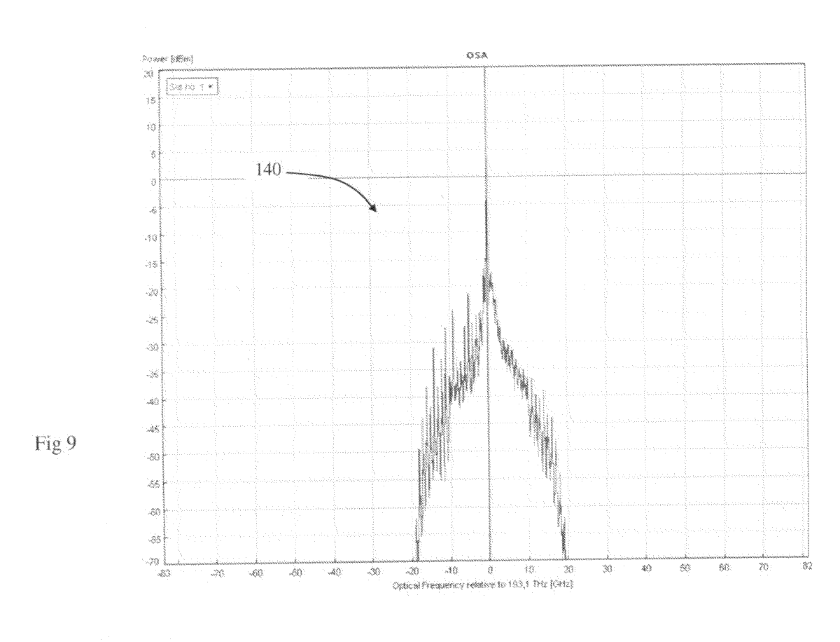

FIG. 9 shows a final output spectrum of the carrier recovery circuit of FIG. 8;

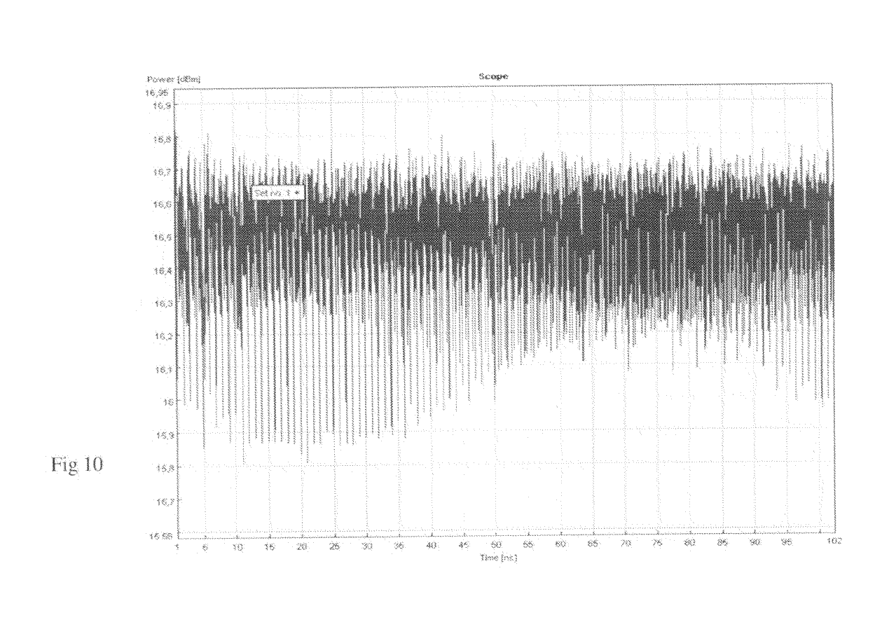

FIG. 10 shows residual power fluctuations of a final output of the carrier recovery circuit of FIG. 8;

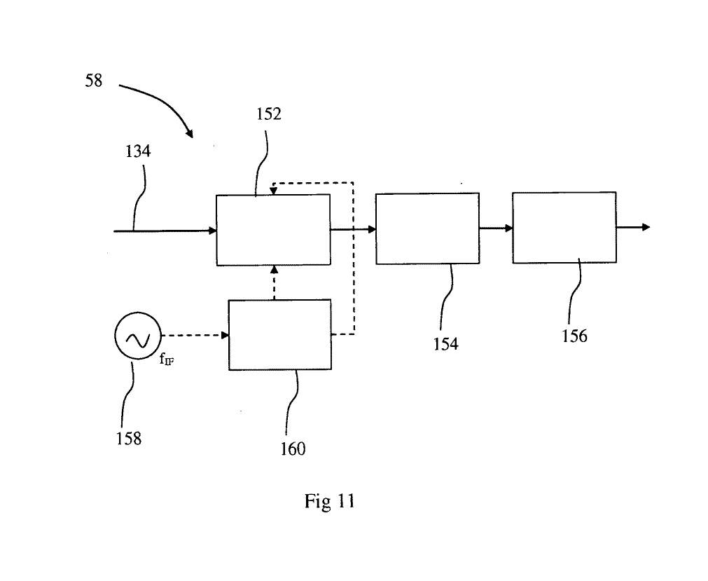

FIG. 11 shows the optical frequency shifter of FIG. 2 in greater detail;

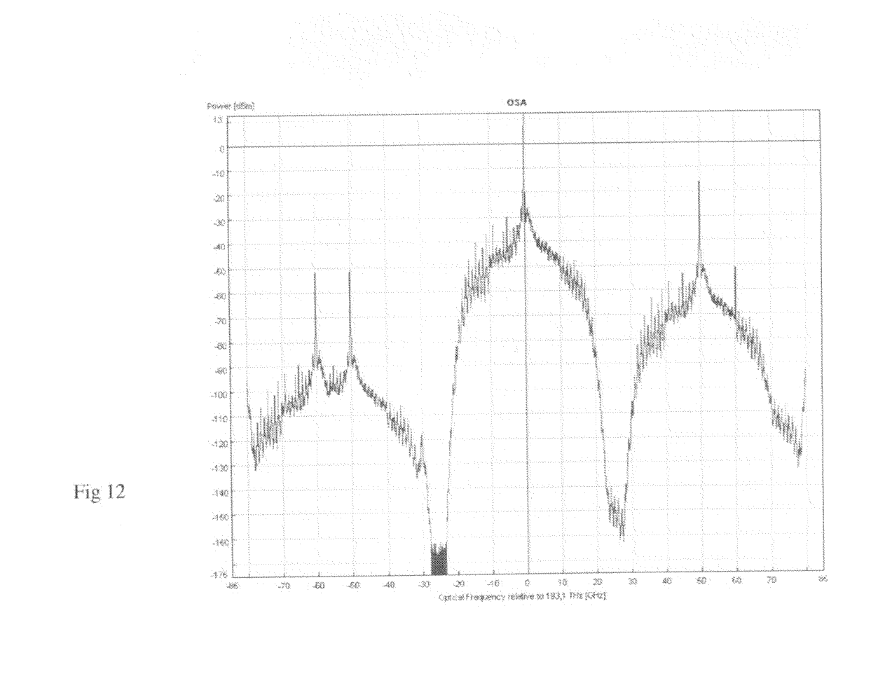

FIG. 12 shows an unfiltered OSSB modulated spectra;

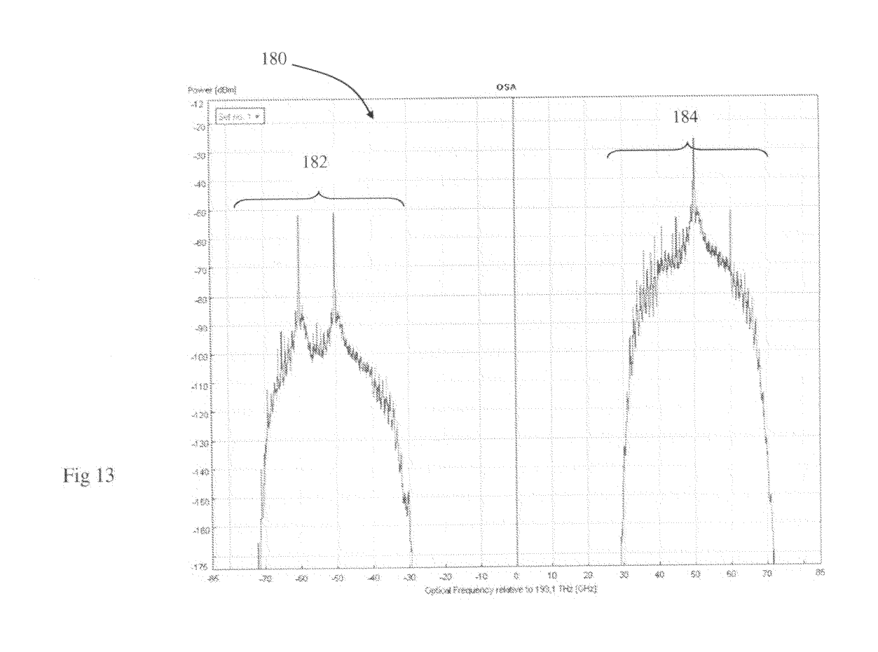

FIG. 13 shows the filtered OSSB modulated spectra;

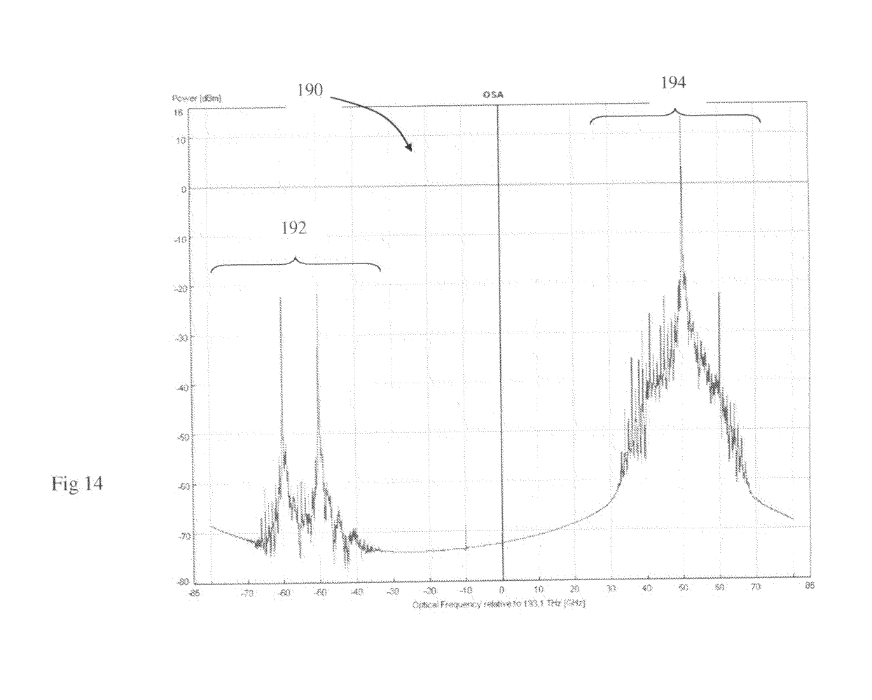

FIG. 14 shows a final spectrum that is output from the frequency shifter shown in FIG. 11; and

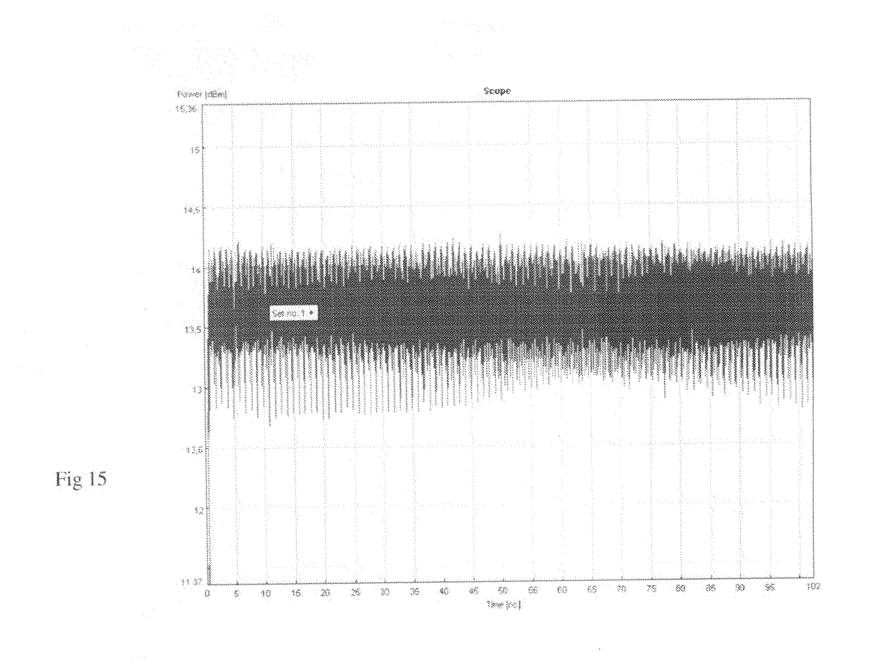

FIG. 15 shows the residual amplitude fluctuation that are present in the final spectrum.

FIG. 1 shows a network according to an embodiment of the invention, generally designated 10. The network 10 has an Optical Line Terminal (OLT) 12 which is an edge device of a larger network which may have many OLTs (not shown). The OLT 12 provides communications services to a plurality of users 14, 16, 18 via Subcarrier Multiplexing (SCM). The SCM signal is generated at the OLT 12 in a SCM transmitter 13 by frequency multiplexing an unmodulated optical carrier and an arbitrary number of modulated Radio Frequency (RF) signals, also known as subcarriers, which corresponds to the number of users 14, 16, 18. This is performed according to known techniques and will not be described further. The SCM signal is then passed to a single optical fibre 18 via an OLT circulator 20. The optical fibre 18 is in communication with a user circulator 22 which is in communication with a demodulator 24. The demodulator 24 may be simply a photodiode followed by an electrical amplifier having a linear response. After the SCM signal is demodulated the subcarriers are separated by standard RF techniques with RF band-pass filters or local oscillators followed by low pass filters. Such techniques are known and will not be described further. Once the subcarriers have been separated they are passed to the users 14, 16, 18 by a distributor 26. This may be achieved via radio, cable, optical fibre or copper wire. FIG. 1 also shows the single carrier frequencies 34, 36, 38 that are used for communication with the users 14, 16, 18, and the combined SCM signal 40 which is present in the optic fibre 18.

In the upstream direction the subcarriers from the users 14, 16, 18 are combined at an aggregation device 28 which is described in detail below. The combined signals are then passed on to an upstream modulator 30 and then on to the user circulator 22 for onward transmission to the OLT 12. At the OLT 12 the combined subcarriers are input to the OLT circulator 20 and they are then received at an SCM receiver 32. The circulators 20, 22 allow propagation to be bidirectional using a single optical fibre 18. Such an arrangement is attractive because the upstream and downstream signals share the same fibre and thereby maximize the system efficiency whilst keeping costs to a minimum.

FIG. 1 also shows an optical tap 46 between the user circulator 22 and the demodulator 24. The optical tap 46 provides about 40% of the optical power of the SCM modulated downstream signal to an optical circuit 50. The remaining 60% of the SCM modulated downstream signal is passed to the demodulator 24. The optical circuit 50 is in communication with the upstream modulator 30.

FIG. 2 shows the optical circuit 50 of FIG. 1 in greater detail according to an embodiment of the invention. In FIG. 2 solid lines correspond to optical links whereas dashed lines correspond to electrical connections. The optical circuit 50 has an input optical fibre 52 and an output optical fibre 54 from the optical tap 46 and to the upstream modulator 30 respectively, as shown in FIG. 1. The input optical fibre 52 of FIG. 2 is in communication with an optical carrier recovery device 56 which operates to eliminate the SCM subcarriers (i.e. the SCM modulating signal). The optical carrier recovery device 56 is in communication with an optical frequency shifter 58 which operates to shift the optical subcarrier by means of a frequency conversion technique which does not use a laser. Instead the frequency conversion technique relies on a local RF oscillator as discussed below which operates at an intermediate frequency f_{IF} which is input to the optical frequency shifter 58 as shown at 60.

FIG. 2 shows the basic operation of the optical circuit 50 whereby the SCM modulated downstream signal is input at 64 and comprises the optical subcarrier frequency f_{c} and SCM subcarriers which are separated by an amount Δf. The optical carrier recovery device 56 then operates to eliminate the SCM subcarriers as shown at 66. The intermediate frequency f_{IF} is input at 60 to the optical frequency shifter 58 which operates to shift the frequency of the optical subcarrier to the right as shown at 68 and indicated by the notation f_{c}-f_{IF}. The way in which these functions are performed will now be described in greater detail below.

FIG. 3 shows a delay line interferometer 57 which is part of the optical carrier recovery device 56 of FIG. 2. In FIG. 3 the delay line interferometer 57 comprises an input interferometer coupler 70 and an output interferometer coupler 72. The outputs of the input interferometer coupler 70 are connected to the inputs of the output interferometer coupler 72. Together the input interferometer coupler 70 and the output interferometer coupler 72 provide the delay line interferometer 57, which has inputs i₁, i₂ and outputs o₁ and o₂. The SCM modulated downstream signal shown at 64 in FIG. 2 feeds the input i₁, while no signal is present at the other input i₂.

The output of the delay line interferometer 57 depends on the particular shape of the subcarrier modulated spectrum, composed by equally spaced subcarriers, that are input to it. The delay line interferometer 57 works when Δf is the frequency separation between two adjacent subcarriers and the distance between the optical carrier and the first subcarrier is Δf/2+k·Δf where k is an arbitrary integer number. The upper and lower arms of the delay line interferometer 57 represent a phase shift π radians as shown at 74 and a relative delay of Δf⁻¹ as shown at 76. The operation principle and the frequency response H(f) is shown in the equations (1), (2), and (3) below where f indicates the frequency offset from the optical carrier frequency f_{C}.

$$\begin{matrix}H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) & ( 1 ) \\ {H}_{11} ( f ) = 0.5 \cdot ( 1 + {e}^{- i \cdot 2 \cdot π \cdot f / Δ F} ) & ( 2 ) \\ {H}_{12} ( f ) = - 0.5 i \cdot ( 1 - {e}^{- i \cdot 2 \cdot π \cdot f / Δ F} ) & ( 3 )\end{matrix}$$

The frequency response H₁₁ relates to the transformation function from the input i₁ to the output o₁. The frequency response H₁₂ relates to the transformation function from the input i₁ to the output o₂.

A plot of the main H(f) function of equation (1) is shown in FIG. 4, generally designated 80. The plot for H₁₁ is shown as a solid graph, whereas the plot for H₁₂ is shown as a dotted graph. In FIG. 4 the y-axis shows the magnitude whereas the x-axis shows the product f·T. It can be seen from FIG. 4, and it can easily be verified, that H₁₁(f) is zero for the frequencies fₙ=ΔF/2+n·αF which correspond to the subcarriers, and that H₁₁(f) is a maximum for fₙ=0 which correspond to the optical carrier. In the ideal model only the carrier is present at the output o₁ shown in FIG. 3, whereas only the subcarriers are present at the output o₂ shown in FIG. 3. It will be appreciated that the signal at o₂ can be used to control and stabilize the relative phase shift ΔΦ which should be at a minimum after photodetection and filtering by an electrical low pass filter with a cut-off frequency lower than Δf.

FIG. 5 shows an input SCM spectrum at the input port i₁ shown in FIG. 3, generally designated 90. In FIG. 5 the y-axis represents the output power in dBm and the x-axis represents the optical frequency relative to 193.1 THz (GHz). The SCM spectrum 90 shows a maximum at zero 92 on the x-axis. The SCM spectrum 90 also shows ten subcarriers at 94 to the left of the x=0 line, and ten subcarriers at 96 to the right of the x=0 line. The twenty subcarriers 94, 96 have a modulation index=0.4/√10 and an optical power of −5 dBm.

FIGS. 6 and 7 show the output spectrum at the output ports of o₁ and o₂ generally designated 100 and 110 respectively. In FIGS. 6 and 7 the y-axis represents the output power in dBm and the x-axis represents the optical frequency relative to 193.1 THz (GHz). In FIG. 6 only the carrier can be seen at 102, whereas only the ten subcarriers 112, 114 either side of the x=0 line can be seen in FIG. 7.

FIG. 8 shows the complete carrier recovery circuit 56 of FIG. 2. In FIG. 8 solid lines indicate optical connections and dashed lines indicate electrical connections. The input i₂ is shown connected to an optical ground at 121 to indicate that there is no light input at i₂ such that this input is dark. The delay line interferometer 57 outputs the signal at o₁ to a Semiconductor Optical Amplifier (SOA) 120 and then to an optical band pass filter 122 which are used to amplify and remove any unwanted out of band frequencies. The optical band pass filter 122 is a 4th order Gaussian filter with a Full Width Half Maximum (FWHM) of 30 GHz in order to further reduce any amplitude fluctuations. It will be appreciated that to ensure colourless operation over an equally spaced grid, for example, a 100 GHz ITU-T grid, the band pass filter 122 can be replaced by a comb filter, which has a frequency response which is the same as the band pass filter 122. A practical example of a comb filter is a delay line interferometer or a Fabry-Perot filter.

The SOA 120 of FIG. 8 has an injection current of 150 mA, a length of 500 μm, an active layer area of 0.24 μm², an optical confinement factor of 0.15, an internal loss of 40×10² m⁻¹ of internal losses, a differential gain of 2.78×10−20 m², a carrier density transparency threshold of 1.4×108 s⁻¹, a linewidth enhancement factor of 5, a linear recombination coefficient of 1.43×108 s⁻¹, a biomolecular recombination coefficient of 1.0×10⁻¹⁶ m³·s⁻¹, and an Auger recombination coefficient of 3.0×10⁻⁴¹m⁶·s⁻¹.

FIG. 8 also shows a control circuit 124 which is used to provide an electrical control signal, shown in FIGS. 3 and 8 at 126, to one arm of the delay line interferometer 57. In FIG. 8 the control circuit 124 accepts the output o₂ at a photodiode 128 and then passes the signal to a low pass filter 130. A digital signal processor 132 is then used to process the signal and to provide the control signal 126 to the delay line interferometer 57. The control signal 126 should be zero and is used to provide a feedback mechanism to maintain a steady output so that the comb of frequencies does not drift. It will be appreciated that whilst the signal output at o₂ is relatively clean there may be some losses and the arrangements of FIG. 8 are used to amplify and filter it. The final output spectrum of the carrier recovery circuit at 134 is shown in FIG. 9 at 140. The output spectrum 140 can be seen to be greatly improved when compared to the output signal o₁ shown in FIG. 6. The residual power fluctuation of the output at 134 is shown in FIG. 10 which illustrates that these are very good at about ±0.5 dBm from about 15.8 dBm to 16.8 dBm.

Once the modulated signal has been removed using the carrier recovery circuit 56, the optical carrier frequency can be shifted using Optical. Signal Side Band (OSSB) modulation. This can be achieved using an optical frequency shifter 58 shown in FIG. 2 which is now described in greater detail with reference to FIG. 11. The optical frequency shifter 58 receives the signal output from the carrier recovery circuit 56 shown at 134 in FIG. 8. In FIG. 11 this signal is input to a dual arm Mach-Zender modulator 152. The Mach-Zender modulator 152 is followed by an optical band pass filter 154 or a comb filter (for example a 100 GHz periodic comb filter), for colourless operation which is centred on a side row generated by the modulating tone. The frequency separation between the side optical carrier and the side row is equal to the frequency of the modulating tone. According to a known technique, to generate this side row it is necessary to bias the Mach Zender modulator 152 at the quadrature point and introduce a phase shift of π/2 between the two arms of the Mach Zender modulator 152, both having as input the modulating tone itself. It will be appreciated that the original carrier is strongly attenuated because it is suppressed by the optical band pass filter 154, or because it coincides with a minima of the periodic response of the comb filter if this type of filter is used. For this reason the signal is then passed to a semiconductor optical amplifier 156 to compensate for the modulator losses.

The Mach-Zender interferometer 152 performs OSSB modulation on the recovered carrier using a pure tone generated from a radio frequency oscillator 158. The pure tone has an intermediate frequency f_{IF}, which is a radio frequency signal corresponding to the desired frequency offset. The pure tone is input to a radio frequency hybrid coupler 160 using a know technique which outputs two signals at the same intermediate frequency f_{IF} but with a phase shift of π/2. These two signals are input to the dual arm Mach-Zender modulator 152 to drive it whereby the lower arm has a bias of V_{π}/2 and a phase shift of π/2 with respect to the upper arm. V_{π} is a parameter typical of Mach-Zender modulators and is the voltage value for which the electrical field at the optical output of the Mach-Zender modulator 152 is shifted by π radians with respect to the electrical filed at the optical input. It will be appreciated that OSSB modulation is slightly more complicated than standard amplitude modulation but allows periodic comb filters to be used instead of single wavelength filters which ensures colourless operation over an equally spaced grid, such as the ITU-T channels frequencies in a WDM system.

It will also be appreciated that the optical band pass filter 122 after the carrier recovery circuit 57 shown in FIG. 8 and the optical band pass filter 154 after the Mach-Sender modulator 152 shown in FIG. 11 must be relatively shifted by an amount equal to the intermediate frequency, for example 50 GHz. This is to avoid any interference that may otherwise be caused.

FIG. 12 shows the unfiltered OSSB modulated spectra, generally designated 170, that is output after the Mach-Zender modulator shown in FIG. 11. In FIG. 12 the spectra comprises three sub-spectra 172, 174 and 176. FIG. 13 shows the filtered OSSB modulated spectra, generally designated 180, that is output after the optical band pass filter 154 shown in FIG. 11. In FIG. 13 the spectra has been reduced so that it comprises two sub-spectra 182, 184 whereby the central sub-spectra 174 shown in FIG. 12 has been eliminated due to the presence of the optical band pass filter 154.

FIG. 14 shows the final spectrum, generally designated 190, that is output after the semiconductor amplifier 156 of FIG. 11. FIG. 14 shows the two remaining sub-spectra 192, 194, FIG. 15 shows the residual amplitude fluctuation that are present in the final spectrum 190 and illustrates that the residual amplitude fluctuation is about ±0.75 dBm which is very small and confirms the successful operation of the overall optical circuit 50. Only the right hand spectra 194 of FIG. 14 is input to the upstream modulator 30 shown in FIG. 1 for upstream transmission of the SCM signal.

The advantages of the above described embodiments are that the downstream SCM signal is reused to generate the upstream optical carrier. This avoids the requirement for expensive laser equipment at or near to the user location. The frequency of the upstream and the downstream carriers are different which also avoids any problems due to reflection points between the OLT 12 and the users 14, 16, 18 shown in FIG. 1. The optical circuit 50 could be realised in a single, compact optical device which may further reduce the associated costs.

It will be appreciated that in a real world system many optical fibres 18 may be in communication with the OLT 12 of FIG. 1 such that many SCM signals can be multiplexed/demultiplexed prior to transmission in the upstream or downstream direction. The skilled person will know the requirements for such an arrangement based on the principles as shown with reference to FIGS. 1-15. It will also be appreciated by those skilled in the art that the above-described embodiments are particularly, but not exclusively, relevant to SCM.

1.-36. (canceled)

37. A method of operating a multicarrier communications system for communication between an optical line terminal and a plurality of users over a single optical fibre comprising;
inputting a portion of a downstream optical signal to an optical circuit, the downstream signal comprising a plurality of subcarriers modulated at a first frequency;
processing the portion of the downstream optical signal at the optical circuit to remove the plurality of subcarriers and to change the first frequency into a second frequency; and
using the processed portion of the downstream signal for communication in the upstream direction.

38. A method according to claim 37 and further including using an optical tap for inputting the portion of the downstream optical signal to the optical circuit.

39. A method according to claim 37 and further including using an optical carrier recovery device to remove the plurality of subcarriers.

40. A method according to claim 39 and further including using a delay line interferometer in the optical carrier recovery device to introduce a phase shift of π radians and a relative delay of Δf⁻¹ where Δf is the frequency separation between two adjacent subcarriers.

41. A method according to claim 40 and further including using the delay line interferometer to produce a frequency response H(f) according to the equation:
$$H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) ,$$
where f is a frequency offset from the first frequency.

42. A method according to claim 37 and further including using an optical frequency shifter to change the first frequency into the second frequency.

43. A method according to claim 42 and further including performing Optical Signal Side Band (OSSB) modulation to produce the second frequency.

44. A method according to claim 43 and further including using a dual arm Mach-Zender modulator to the perform Optical Signal Side Band (OSSB) modulation.

45. A method according to claim 37 and further including inputting the processed portion of the downstream signal to an upstream modulator for communication in the upstream direction.

46. A multicarrier communications system for communication between an optical line terminal and a plurality of users over a single optical fibre comprising;
an optical circuit for receiving a portion of a downstream optical signal, the downstream signal comprising a plurality of subcarriers modulated at a first frequency;
the optical circuit comprising an optical carrier recovery device and an optical frequency shifter to process the portion of the downstream optical signal to remove the plurality of subcarriers and to change the first frequency into a second frequency; wherein the processed portion of the downstream signal is arranged for communication in the upstream direction.

47. A multicarrier communications system according to claim 46 wherein the multicarrier communication system is a sub-carrier multiplexing carrier system.

48. An optical circuit for receiving a portion of a downstream optical signal in a multicarrier communications system for communication between an optical line terminal and a plurality of users over a single optical fibre, the downstream signal comprising a plurality of subcarriers modulated at a first frequency,
the optical circuit comprising an optical carrier recovery device and an optical frequency shifter to process the portion of the downstream optical signal to remove the plurality of subcarriers and to change the first frequency into a second frequency, wherein the processed portion of the downstream signal is arranged for communication in the upstream direction.

49. An optical circuit according to claim 48 including a delay line interferometer in the optical carrier recovery circuit to introduce a phase shift of π radians and a relative delay of Δf⁻¹ where Δf is the frequency separation between two adjacent subcarriers.

50. An optical circuit according to claim 49 and further including operating the delay line interferometer to produce a frequency response H(f) according to the equation:
$$H ( f ) = ( \begin{matrix}1 / \sqrt{2} & i / \sqrt{2} \\ i / \sqrt{2} & 1 / \sqrt{2}\end{matrix} ) \cdot ( \begin{matrix}exp ( - i \cdot 2 \cdot π \cdot f \cdot T ) & 0 \\ 0 & exp ( i \cdot ΔΦ )\end{matrix} ) \cdot ( \begin{matrix}1 / \sqrt{2} & i / \sqrt{2} \\ i / \sqrt{2} & 1 / \sqrt{2}\end{matrix} ) ,$$
where f is a frequency offset from the first frequency.

51. An optical circuit according to claim 49 and further including a control circuit to control the delay line interferometer.

52. An optical circuit according to claim 48 and further including a dual arm Mach-Zender modulator to perform the Optical Signal Side Band (OSSB) modulation.

53. An optical circuit according to claim 48 and further including an upstream modulator to receive the processed portion of the downstream signal for communication in the upstream direction.

54. A communications network including an optical circuit for receiving a portion of a downstream optical signal in a multicarrier communications system for communication between an optical line terminal and a plurality of users over a single optical fibre, the downstream signal comprising a plurality of subcarriers modulated at a first frequency,
the optical circuit comprising an optical carrier recovery device and an optical frequency shifter to process the portion of the downstream optical signal to remove the plurality of subcarriers and to change the first frequency into a second frequency, wherein the processed portion of the downstream signal is arranged for communication in the upstream direction.
